(19) United States
(12) Patent Application Publication
(10) Pub. No.: US 2024/0240109 A1
(43) Pub. Date: Jul. 18, 2024

(54) LIQUID HAND DISHWASHING DETERGENT COMPOSITION

(71) Applicant: The Procter & Gamble Company, Cincinnati, OH (US)

(72) Inventors: Jana Verena Margarethe HERZBERGER, Florence, KY (US); Pieter Jan Maria SAVEYN, Heusden (BE); Evelyne Johanna Lutgarde VAN HECKE, Bachte - Maria - Leerne (BE)

(21) Appl. No.: 18/407,490

(22) Filed: Jan. 9, 2024

Related U.S. Application Data
(60) Provisional application No. 63/438,798, filed on Jan. 13, 2023.

(30) Foreign Application Priority Data
Jan. 19, 2023 (EP) 23152334.1
Sep. 26, 2023 (EP) 23199749.5

(51) Int. Cl. C11D 1/00; C11D 1/29; C11D 1/65; C11D 1/66; C11D 1/86; C11D 1/88; C11D 1/90

(52) U.S. Cl. CPC C11D 1/008; C11D 1/29; C11D 1/65; C11D 1/662; C11D 1/86; C11D 1/88; C11D 1/90; C11D 2111/14

(57) ABSTRACT

A liquid hand dishwashing detergent composition including from about 5.0% to about 50% by weight of the liquid hand dishwashing detergent composition of a surfactant system, wherein the surfactant system comprises anionic surfactant; and from about 0.01% to about 5% of a hydrophobically modified cationic polyvinyl alcohol. A method of cleaning dishes includes delivering the composition to a volume of water to form a wash solution; and immersing the dishware in the wash solution.

### TECHNICAL FIELD

The present disclosure relates to liquid hand dishwashing detergent compositions.

### BACKGROUND

Manual dishwashing is a time-consuming task and there is an increasing desire to spend less time and effort washing dishware.

During manual dishwashing, effective foaming and rinsing of the foam is important for consumers. Long lasting foam during the washing step signals product effectiveness to the consumer, while easy rinsing of the foam enables faster rinsing and the use of less water by the consumer during the washing cycle. To provide good foaming and cleaning benefits, formulators of hand dishwashing detergent compositions have traditionally formulated with anionic surfactants, including alkyl sulphated anionic surfactants. However, a drawback to these anionic surfactants, including alkyl sulphated anionic surfactants, is sacrificing foam rinsing properties. As such, long rinse times are often required to remove all the suds from the dishware being washed. Moreover, manual dishwashing is often only considered complete when the dishware is sufficiently dry to be put away.

Cationically modified hydroxyethyl cellulose has also been found to provide efficient foam rinsing. For instance, JP6640055B2, JP2019172819A, JP2018035251A, JP2018035252A and JP2020152757A all describe liquid detergent composition for dishes which comprise cationized cellulose and have improved detergency, foaming properties and drainability. However, cationically modified hydroxyethyl cellulose also has several drawbacks, including an increase in finished product viscosity and poor solution feel, for example, giving the wash solution a slippery or oily feel. Various other polymers have been used to improve sudsing, such as the hydroxypropylcellulose polymers described in EP4089159A, or as viscosity modifiers, such as the hydroxyethylcellulose polymers described in GB2427614A. Polyvinyl alcohols, such as those described in EP3730594A1 have been found to provide improved suds longevity, though this is at the expense of rinsability. Copolymers of polyvinyl alcohol, such as those described in EP application EP22180286.1 have also been found to further improve suds longevity.

Accordingly, there is a need for a liquid detergent composition that provides good foaming while also providing improved rinsing and fast drying, and hence requires less time and effort for manual dishwashing.

Wang and Ye (J. Polym. Int. 2012; 61 pp 571-580) describe the structure and properties of hydrophobic cationic polyvinyl alcohol. Ma et al. (J. Appl. Polym. Sci. 2016, 133, 43888) described the functional modification of polyvinyl alcohol by copolymerizing with a hydrophobic cationic double alkyl-substituted monomer.

US2020/114328A relates to a mineralized core-shell microcapsule slurry including at least one microcapsule having: an oil-based core including a hydrophobic active ingredient; a polymeric shell having a terminating charged functional surface; and a mineral layer on the terminating charged functional surface, as well as a process for a preparation of such microcapsules. US2017/354945A relates to an aqueous dispersion of microcapsules, wherein the shell of the microcapsules comprises at least one polyurea and the core comprises one or more lipophilic components with the proviso that the core does not contain a fragrance, and having a percentage of the shell weight with reference to the total weight of the capsules of 5 to 40% and wherein the microcapsules have a volume average diameter of 15 to 90 μm and the dispersion comprises hydroxyalkylcellulose and the use of such a dispersion. US2020/339914A relates to a liquid hand dishwashing cleaning composition that is less hazy, while also provides reduced surface tension between the detergent composition and the soiled plate, and hence improvements in cleaning, the liquid hand dishwashing cleaning composition is formulated with a surfactant system and a polyvinyl alcohol having a degree of hydrolysis of from about 40% to about 86%.

### SUMMARY

The present disclosure relates to a liquid hand dishwashing detergent composition comprising: from 5.0% to 50% by weight of the liquid hand dishwashing detergent composition of a surfactant system, wherein the surfactant system comprises anionic surfactant; and from 0.01% to 5% of a hydrophobically modified cationic polyvinyl alcohol.

### BRIEF DESCRIPTION OF THE DRAWING

FIG. 1 shows the reaction scheme for the quaternization of 4-(dimethylamino)butyraldehyde diethyl acetal (cationic acetal).

### DETAILED DESCRIPTION

Surprisingly, it has been found that formulating liquid hand dishwashing detergent compositions containing hydrophobically modified cationic polyvinyl alcohols results in the composition providing good foaming during use, while also being easier to rinse, and having shorter drying times.

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present disclosure can comprise, consist of, and consist essentially of the essential elements and limitations of the present disclosure described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease in the material) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

As used herein, the term “polysaccharide” means a polymeric carbohydrate molecule composed of long chains of monosaccharide units bound together by glycosidic linkages and on hydrolysis gives the constituent monosaccharides or oligosaccharides.

A “cationic derivative of a polysaccharide” is understood to be a polysaccharide or a derivate of a polysaccharide comprising a cationic group. The cationic group may comprise an ammonium group, a quaternary ammonium group, a sulfonium group, a phosphonium group, a transitional metal or any other positively charged functional group. A preferred cationic group is a quaternary ammonium group.

The term “sudsing profile” as used herein refers to the properties of the composition relating to suds character during the dishwashing process. The term “sudsing profile” of the composition includes initial suds volume generated upon dissolving and agitation, typically manual agitation, of the composition in the aqueous washing solution, and the retention of the suds during the dishwashing process. Preferably, hand dishwashing compositions characterized as having “good sudsing profile” tend to have high initial suds volume and/or sustained suds volume, particularly during a substantial portion of or for the entire manual dishwashing process. This is important as the consumer uses high suds as an indicator that enough composition has been dosed. Moreover, the consumer also uses the sustained suds volume as an indicator that enough active cleaning ingredients (e.g., surfactants) are present, even towards the end of the dishwashing process. The consumer usually renews the washing solution when the sudsing subsides. Thus, a low sudsing composition will tend to be replaced by the consumer more frequently than is necessary because of the low sudsing level.

“Easy rinsing” or “an easy rinsing profile” means that the foam generated during the main wash cycle can be rinsed faster and less water can be used to collapse the foam from the main wash cycle. Faster collapsing of the foam is preferred to reduce the amount of time spent rinsing and overall washing time, as well. Reducing the amount of water used to collapse the foam is preferred because it aids in water conservation.

It is understood that the test methods that are disclosed in the Test Methods Section of the present application must be used to determine the respective values of the parameters of Applicants' present disclosures as described and claimed herein.

All percentages are by weight of the total composition, as evident by the context, unless specifically stated otherwise. All ratios are weight ratios, unless specifically stated otherwise, and all measurements are made at 25° C., unless otherwise designated.

### Liquid Hand Dishwashing Detergent Composition

The composition is a liquid cleaning composition, which is a liquid hand dishwashing composition, and hence is in liquid form. The liquid hand dishwashing composition is preferably an aqueous composition. As such, the composition can comprise from 50% to 85%, preferably from 50% to 75%, by weight of the total composition of water.

The liquid composition may have a pH greater than or equal to 6.0, or a pH of from 6.0 to 12.0, preferably from 7.0 to 11.0, more preferably from 7.5 to 10.0, measured as a 10% aqueous solution in demineralized water at 20° C.

The composition of the present disclosure can be Newtonian or non-Newtonian, preferably Newtonian, over the usage shear rate range which is typically from 0.1 s⁻¹ to 100 s⁻¹. Preferably, when Newtonian, the composition has a viscosity of from 10 mPa·s to 10,000 mPa's, preferably from 100 mPa·s to 5,000 mPa·s, more preferably from 300 mPa·s to 2,000 mPa·s, or most preferably from 500 mPa·s to 1,500 mPa·s, alternatively combinations thereof, over the typical usage shear rate range.

### Surfactant System

The liquid composition comprises from 5.0% to 50%, preferably from 6.0% to 40%, most preferably from 15% to 35%, by weight of the total composition of a surfactant system.

### Anionic Surfactant

The surfactant system comprises an anionic surfactant. The surfactant system can comprise at least 40%, preferably from 50% to 80%, more preferably from 55% to 70% by weight of the surfactant system of the anionic surfactant. The surfactant system is preferably free of fatty acid or salt thereof, since such fatty acids impede the generation of suds.

Suitable anionic surfactants can be selected from the group consisting of: alkyl sulphate surfactant, alkyl alkoxy sulphate surfactant, alkyl sulphonate surfactant, alkyl sulphosuccinate and dialkyl sulphosuccinate ester surfactants, and mixtures thereof.

The anionic surfactant can comprise at least 70%, preferably at least 85%, more preferably 100% by weight of the anionic surfactant of alkyl sulphate anionic surfactant, alkyl alkoxy sulphate anionic surfactant, or a mixture thereof.

The mol average alkyl chain length of the alkyl sulphate anionic surfactant or the alkyl alkoxy sulphate anionic surfactant can be from 8 to 18, preferably from 10 to 14, more preferably from 12 to 14, most preferably from 12 to 13 carbon atoms, in order to provide a combination of improved grease removal and enhanced speed of cleaning.

The alkyl chain of the alkyl sulphate anionic surfactant or the alkyl alkoxy sulphate anionic surfactant can have a mol fraction of C12 and C13 chains of at least 50%, preferably at least 65%, more preferably at least 80%, most preferably at least 90%. Suds mileage is particularly improved, especially in the presence of greasy soils, when the C13/C12 mol ratio of the alkyl chain is at least 57/43, preferably from 60/40 to 90/10, more preferably from 60/40 to 80/20, most preferably from 60/40 to 70/30, while not compromising suds mileage in the presence of particulate soils.

The relative molar amounts of C13 and C12 alkyl chains in the alkyl sulphate anionic surfactant or the alkyl alkoxy sulphate anionic surfactant can be derived from the carbon chain length distribution of the surfactants. The carbon chain length distributions of the alkyl chains of the alkyl sulphate and alkyl alkoxy sulphate surfactants can be obtained from the technical data sheets from the suppliers for the surfactant or constituent alkyl alcohol. Alternatively, the chain length distribution and average molecular weight of the fatty alcohols, used to make the alkyl sulphate anionic surfactant or the alkyl alkoxy sulphate anionic surfactant, can also be determined by methods known in the art. Such methods include capillary gas chromatography with flame ionization detection on medium polar capillary column, using hexane as the solvent. The chain length distribution is based on the starting alcohol and alkoxylated alcohol. As such, the alkyl sulphate anionic surfactant should be hydrolyzed back to the corresponding alkyl alcohol and alkyl alkoxylated alcohol before analysis, for instance using hydrochloric acid.

The alkyl alkoxy sulphate surfactant can have an average degree of alkoxylation of less than 3.5, preferably from 0.3 to 2.0, more preferably from 0.5 to 0.9, in order to improve low temperature physical stability and improve suds mileage of the compositions of the present disclosure. When alkoxylated, ethoxylation is preferred.

The average degree of alkoxylation is the mol average degree of alkoxylation (i.e., mol average alkoxylation degree) of all the alkyl sulphate anionic surfactant. Hence, when calculating the mol average alkoxylation degree, the mols of non-alkoxylated sulphate anionic surfactant are included:

Mol average alkoxylation degree=(x1*alkoxylation degree of surfactant 1+x2*alkoxylation degree of surfactant 2+ . . . )/(x1+x2+ . . . )
where x1, x2, . . . are the number of moles of each alkyl (or alkoxy) sulphate anionic surfactant of the mixture and alkoxylation degree is the number of alkoxy groups in each alkyl sulphate anionic surfactant.

Preferred alkyl alkoxy sulphates are alkyl ethoxy sulphates.

The alkyl sulphate anionic surfactant and the alkyl alkoxy sulphate anionic surfactant can have a weight average degree of branching of at least 10%, preferably from 20% to 60%, more preferably from 30% to 50%. Alternatively, the alkyl sulphate anionic surfactant and the alkyl alkoxy sulphate anionic surfactant can have a weight average degree of branching of less than 10%, preferably the alkyl sulphate anionic surfactant and the alkyl alkoxy sulphate anionic surfactant are free of branching.

The alkyl sulphate anionic surfactant and the alkyl alkoxy sulphate anionic surfactant can comprise at least 5%, preferably at least 10%, most preferably at least 25%, by weight of the surfactant, of branching on the C2 position (as measured counting carbon atoms from the sulphate group for non-alkoxylated alkyl sulphate anionic surfactants and counting from the alkoxy-group furthest from the sulphate group for alkoxylated alkyl sulphate anionic surfactants). More preferably, greater than 75%, even more preferably greater than 90%, by weight of the total branched alkyl content consists of C1-C5 alkyl moiety, preferably C1-C2 alkyl moiety. It has been found that formulating the inventive compositions using alkyl sulphate surfactants or alkyl alkoxy sulphate surfactants having the aforementioned degree of branching results in improved low temperature stability. Such compositions require less solvent in order to achieve good physical stability at low temperatures. As such, the compositions can comprise lower levels of organic solvent, such as less than 5.0% by weight of the liquid composition of organic solvent, while still having improved low temperature stability. Higher surfactant branching also provides faster initial suds generation, but typically less suds mileage. The weight average branching, described herein, has been found to provide improved low temperature stability, initial foam generation and suds longevity.

The weight average degree of branching for an anionic surfactant mixture can be calculated using the following formula:

Weight average degree of branching (%)=[(x1*wt % branched alcohol 1 in alcohol 1+x2*wt % branched alcohol 2 in alcohol 2+ . . . )/(x1+x2+ . . . )]*100
where x1, x2, . . . are the weight in grams of each alcohol in the total alcohol mixture of the alcohols which were used as starting material before (alkoxylation and) sulphation to produce the alkyl (alkoxy) sulphate anionic surfactant. In the weight average degree of branching calculation, the weight of the alkyl alcohol used to form the alkyl sulphate anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionization detection on medium polar capillary column, using hexane as the solvent. The weight average degree of branching and the distribution of branching is based on the starting alcohol used to produce the alkyl sulphate anionic surfactant.

Suitable counterions include alkali metal cation earth alkali metal cation, alkanolammonium or ammonium or substituted ammonium, but preferably sodium.

Suitable examples of commercially available alkyl sulphate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols can be blended in order to achieve the desired mol fraction of C12 and C13 chains and the desired C13/C12 ratio, based on the relative fractions of C13 and C12 within the starting alcohols, as obtained from the technical data sheets from the suppliers or from analysis using methods known in the art.

The performance can be affected by the width of the alkoxylation distribution of the alkoxylated alkyl sulphate anionic surfactant, including grease cleaning, sudsing, low temperature stability and viscosity of the finished product. The alkoxylation distribution, including its broadness can be varied through the selection of catalyst and process conditions when making the alkoxylated alkyl sulphate anionic surfactant.

If ethoxylated alkyl sulphate is present, without wishing to be bound by theory, through tight control of processing conditions and feedstock material compositions, both during alkoxylation especially ethoxylation and sulphation steps, the amount of 1,4-dioxane by-product within alkoxylated especially ethoxylated alkyl sulphates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alkyl sulphates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N-methyl amino)-L-alanine, and mixtures thereof.

Anionic alkyl sulphonate or sulphonic acid surfactants suitable for use herein include the acid and salt forms of alkylbenzene sulphonates, alkyl ester sulphonates, primary and secondary alkane sulphonates such as paraffin sulfonates, alfa or internal olefin sulphonates, alkyl sulphonated (poly)carboxylic acids, and mixtures thereof. Suitable anionic sulphonate or sulphonic acid surfactants include: C5-C20 alkylbenzene sulphonates, more preferably C10-C16 alkylbenzene sulphonates, more preferably C11-C13 alkylbenzene sulphonates, C5-C20 alkyl ester sulphonates especially C5-C20 methyl ester sulfonates, C6-C22 primary or secondary alkane sulphonates, C5-C20 sulphonated (poly)carboxylic acids, and any mixtures thereof, but preferably C11-C13 alkylbenzene sulphonates. The aforementioned surfactants can vary widely in their 2-phenyl isomer content. Compared with sulfonation of alpha olefins, the sulfonation of internal olefins can occur at any position since the double bond is randomly positioned, which leads to the position of hydrophilic sulfonate and hydroxyl groups of IOS in the middle of the alkyl chain, resulting in a variety of twin-tailed branching structures. Alkane sulphonates include paraffin sulphonates and other secondary alkane sulfonate (such as Hostapur SAS60 from Clariant).

Alkyl sulfosuccinate and dialkyl sulfosuccinate esters are organic compounds with the formula MO3SCH(CO2R′)CH2CO2R where R and R′can be H or alkyl groups, and M is a counter-ion such as sodium (Na). Alkyl sulfosuccinate and dialkyl sulfosuccinate ester surfactants can be alkoxylated or non-alkoxylated, preferably non-alkoxylated. The surfactant system may comprise further anionic surfactant. However, the composition preferably comprises less than 30%, preferably less than 15%, more preferably less than 10% by weight of the surfactant system of further anionic surfactant. Most preferably, the surfactant system comprises no further anionic surfactant, preferably no other anionic surfactant than alkyl sulphated anionic surfactant.

### Co-Surfactant

In order to improve surfactant packing after dilution and hence improve suds mileage, the surfactant system can comprise a co-surfactant. The co-surfactant can be selected from the group consisting of an amphoteric surfactant, a zwitterionic surfactant and mixtures thereof.

The anionic surfactant to the co-surfactant weight ratio can be from 1:1 to 8:1, preferably from 2:1 to 5:1, more preferably from 2.5:1 to 4:1.

The composition preferably comprises from 0.1% to 20%, more preferably from 0.5% to 15% and especially from 2% to 10% by weight of the composition of the co-surfactant.

The surfactant system of the composition of the present disclosure preferably comprises up to 50%, preferably from 10% to 40%, more preferably from 15% to 35%, by weight of the surfactant system of a co-surfactant.

The co-surfactant is preferably an amphoteric surfactant, more preferably an amine oxide surfactant.

The amine oxide surfactant can be linear or branched, though linear are preferred. Suitable linear amine oxides are typically water-soluble and characterized by the formula R1-N(R2)(R3) O wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of methyl, ethyl, propyl, isopropyl, 2-hydroxethyl, 2-hydroxypropyl and 3-hydroxypropyl, and mixtures thereof, though methyl is preferred for one or both of R2 and R3. The linear amine oxide surfactants, in particular, may include linear C10-C18 alkyl dimethyl amine oxides and linear C8-C12 alkoxy ethyl dihydroxy ethyl amine oxides.

Preferably, the amine oxide surfactant is selected from the group consisting of alkyl dimethyl amine oxide, alkyl amido propyl dimethyl amine oxide, and mixtures thereof. Alkyl dimethyl amine oxides are particularly preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, or mixtures thereof. C12-C14 alkyl dimethyl amine oxide is particularly preferred.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein, “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as C1 alkyl.

Alternatively, the amine oxide surfactant can be a mixture of amine oxides comprising a mixture of low-cut amine oxide and mid-cut amine oxide. The amine oxide of the composition of the present disclosure can then comprises:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl, with preferably both R1 and R2 being methyl. In the mid-cut amine oxide of formula R4R5R6AO, R4 and R5 are preferably both methyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

Suitable zwitterionic surfactants include betaine surfactants. Such betaine surfactants includes alkyl betaines, alkylamidobetaine, amidazoliniumbetaine, sulphobetaine (INCI Sultaines) as well as the phosphobetaine, and preferably meets formula (I):

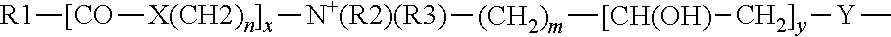

Wherein in formula (I),
R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;
X is selected from the group consisting of: NH, NR4 wherein R4 is a C1-4 alkyl residue, O, and S,
n is an integer from 1 to 10, preferably 2 to 5, more preferably 3,
x is 0 or 1, preferably 1,
R2 and R3 are independently selected from the group consisting of: a C1-4 alkyl residue, hydroxy substituted such as a hydroxyethyl, and mixtures thereof, preferably both R2 and R3 are methyl,
m is an integer from 1 to 4, preferably 1, 2 or 3,
y is 0 or 1, and
Y is selected from the group consisting of: COO, SO₃, OPO(OR5)O or P(O)(OR5)O, wherein R5 is H or a C1-4 alkyl residue.

Preferred betaines are the alkyl betaines of formula (Ia), the alkyl amido propyl betaine of formula (Ib), the sulphobetaine of formula (Ic) and the amido sulphobetaine of formula (Id):

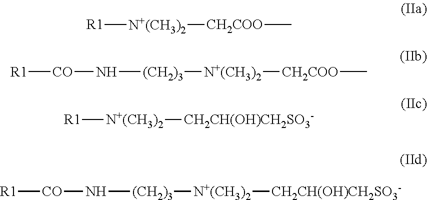

in which R1 has the same meaning as in formula (I). Particularly preferred are the carbobetaines [i.e., where Y=COO in formula (I)] of formulae (Ia) and (Ib), more preferred are the alkylamidobetaine of formula (Ib).

Suitable betaines can be selected from the group consisting or [designated in accordance with INCI]: capryl/capramidopropyl betaine, cetyl betaine, cetyl amidopropyl betaine, cocamidocthyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

### Nonionic Surfactant

The surfactant system can further comprise a nonionic surfactant. Suitable nonionic surfactants include alkoxylated alcohol nonionic surfactants, alkyl polyglucoside nonionic surfactants, and mixtures thereof.

### Alkoxylated Alcohol Nonionic Surfactant

Preferably, the surfactant system of the composition of the present disclosure further comprises from 1% to 25%, preferably from 1.25% to 20%, more preferably from 1.5% to 15%, most preferably from 1.5% to 5%, by weight of the surfactant system, of an alkoxylated alcohol non-ionic surfactant.

Preferably, the alkoxylated alcohol non-ionic surfactant is a linear or branched, primary or secondary alkyl alkoxylated non-ionic surfactant, preferably an alkyl ethoxylated non-ionic surfactant, preferably comprising on average from 9 to 15, preferably from 10 to 14 carbon atoms in its alkyl chain and on average from 5 to 12, preferably from 6 to 10, most preferably from 7 to 8, units of ethylene oxide per mole of alcohol.

### Alkyl Polyglucoside Nonionic Surfactant

If present, the alkyl polyglucoside can be present in the surfactant system at a level of from 0.5% to 20%, preferably from 0.75% to 15%, more preferably from 1% to 10%, most preferably from 1% to 5% by weight of the surfactant composition. Alkyl polyglucoside nonionic surfactants are typically more sudsing than other nonionic surfactants such as alkyl ethoxylated alcohols.

A combination of alkylpolyglucoside and anionic surfactant especially alkyl sulfate anionic surfactant, has been found to improve polymerized grease removal, suds mileage performance, reduced viscosity variation with changes in the surfactant and/or system, and a more sustained Newtonian rheology.

The alkyl polyglucoside surfactant can be selected from C6-C18 alkyl polyglucoside surfactant. The alkyl polyglucoside surfactant can have a number average degree of polymerization of from 0.1 to 3.0, preferably from 1.0 to 2.0, more preferably from 1.2 to 1.6. The alkyl polyglucoside surfactant can comprise a blend of short chain alkyl polyglucoside surfactant having an alkyl chain comprising 10 carbon atoms or less, and mid to long chain alkyl polyglucoside surfactant having an alkyl chain comprising greater than 10 carbon atoms to 18 carbon atoms, preferably from 12 to 14 carbon atoms.

Short chain alkyl polyglucoside surfactants have a monomodal chain length distribution between C8-C10, mid to long chain alkyl polyglucoside surfactants have a monomodal chain length distribution between C10-C18, while mid chain alkyl polyglucoside surfactants have a monomodal chain length distribution between C12-C14. In contrast, C8 to C18 alkyl polyglucoside surfactants typically have a monomodal distribution of alkyl chains between C8 and C18, as with C8 to C16 and the like. As such, a combination of short chain alkyl polyglucoside surfactants with mid to long chain or mid chain alkyl polyglucoside surfactants have a broader distribution of chain lengths, or even a bimodal distribution, than non-blended C8 to C18 alkyl polyglucoside surfactants. Preferably, the weight ratio of short chain alkyl polyglucoside surfactant to long chain alkyl polyglucoside surfactant is from 1:1 to 10:1, preferably from 1.5:1 to 5:1, more preferably from 2:1 to 4:1. It has been found that a blend of such short chain alkyl polyglucoside surfactant and long chain alkyl polyglucoside surfactant results in faster dissolution of the detergent solution in water and improved initial sudsing, in combination with improved suds stability.

C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Glucopon® 215UP is a preferred short chain APG surfactant. Glucopon® 600CSUP is a preferred mid to long chain APG surfactant.

In preferred compositions, the surfactant system can comprise an alkyl sulfate anionic surfactant having an average degree of branching of less than 10% and alkyl polyglucoside nonionic surfactant.

### Hydrophobically Modified Cationic Polyvinyl Alcohol

The liquid hand dishwashing detergent composition comprises a hydrophobically modified cationic polyvinyl alcohol. Hydrophobically modified polymers are water-soluble polymers that contain a small amount of hydrophobic repeat units directly linked to the main chain of the polymer. The hydrophobic repeat units can be introduced into the polymer via polymerisation using hydrophobic monomers and/or via modification after polymerisation. In aqueous solutions, the hydrophobic groups of such polymers tend to associate to minimize their exposure to the aqueous medium, analogous in a way to the micelle formation of a surface active agent above its critical micellar concentration. Such associations result in an increase of the hydrodynamic size, which can affect solution properties such as viscosity, as well as deposition behaviour.

Suitable hydrophobic monomer groups can comprise mixtures of uncharged oligomeric condensates of nonylphenol, for instance having the major component being the bis-nonylphenyl moiety. More preferred hydrophobes are uncharged alkyl chains. For example, the hydrophobically modified cationic polyvinyl alcohol can comprise monomers comprising uncharged alkyl chains having an average of at least 3 carbon atoms, preferably from 3 to 18 carbon atoms, more preferably from 3 to 15 carbon atoms, most preferably from 5 to 10 carbon atoms.

The liquid hand dishwashing detergent composition comprises from 0.01% to 5%, preferably from 0.05% to 3%, more preferably from 0.1% to 2%, even more preferably from 0.25% to 1.0%, by weight of the detergent composition of the hydrophobically modified cationic polyvinyl alcohol.

The cationically modified polyvinyl alcohol can have the formula (I):

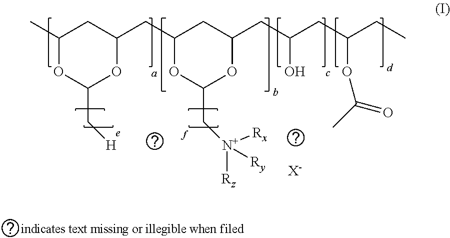

wherein:
a is from 0.5 to 5.0, preferably from 1.0 to 4.0, more preferably from 2.0 to 3.0;
b is from 0.5 to 20, preferably from 2.0 to 10, more preferably from 4.0 to 6.0;
c is from 40 to 98, preferably from 65 to 95, more preferably from 75 to 85; and
d is from 1.0 to 25, preferably from 3.0 to 20, preferably from 8.0 to 15.
a is the average mol % of hydrophobic monomers, b is the average mol % of substituted ammonium and hence cationic monomers, c the average mol % of vinyl alcohol monomers and d is the average mol % of vinyl acetate monomers. a+b+c+d add up to at least 90, preferably at least 98 and more preferably at least 100, excluding residues such as initiation molecules and the like. Where further monomers are present, preferably less than 5%, more preferably less than 1%, most preferably no anionically charged monomers are present. The monomers may be present as blocks or randomly distributed, or a mix of block units and randomly distributed.
e is a number average of from 3.0 to 18, preferably from 3.0 to 15, preferably from 5.0 to 12.

The substituted ammonium group is bound to the polymer backbone via a linking alkyl chain. As such, f is a number average of from 2.0 to 5.0, preferably from 2.0 to 4.0, more preferably 3.0. It has been found that by synthesizing the polymer with the aforementioned values of f, the steric hindrance and charge repulsion which can limit the reaction of the cationic acetal with the polymer can be avoided.

Rx and Ry are independently a C1 to C3 alkyl, preferably a C1 to C3 alkyl, preferably a C1 alkyl, more preferably methyl. Rz is a H or C1 to C3 alkyl, preferably a C1 to C3 alkyl, preferably a C1 alkyl, more preferably methyl. The substituted ammonium group can be a “tertiary ammonium group”, where Rz is H, or “quaternary ammonium” group, where Rz is a C1 to C3 alkyl.

Alternatively, the hydrophobically modified cationic polyvinyl alcohol can have the formula (II):

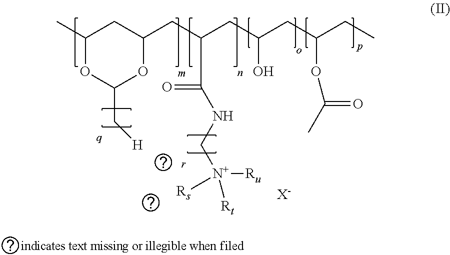

wherein:
m is from 0.5 to 5.0, preferably from 1.0 to 4.0, more preferably from 2.0 to 3.0;
n is from 0.1 to 10, preferably from 0.5 to 5.0, more preferably from 1.0 to 3.0;
o is from 40 to 98, preferably from 65 to 95, more preferably from 75 to 92;
p is from 1.0 to 25, preferably from 3.0 to 20, more preferably from 5.0 to 15;
wherein m, n, o, and p are average mol % of the monomers present, such that m+n+o+p add up to at least 90, preferably at least 98 and more preferably at least 100, excluding residues such as initiation molecules and the like;
q is a number average of from 3.0 to 18, preferably from 3.0 to 15, preferably from 5.0 to 12.

The substituted ammonium group is bound to the polymer backbone via a linking alkyl chain. As such, r is a number average of from 2.0 to 5.0, preferably from 2.0 to 4.0, more preferably 3.0. It has been found that by synthesizing the polymer with the aforementioned values of r, the steric hindrance and charge repulsion which can limit the reaction of the cationic acetal with the polymer can be avoided.
Rₛ is a C1 to C3 alkyl, preferably a C1 alkyl, more preferably methyl;
Rt is a C1 to C3 alkyl, preferably a C1 alkyl, more preferably methyl; and
Ru is a H or C1 to C3 alkyl, preferably a C1 to C3 alkyl, preferably a C1 alkyl, more preferably methyl.

Where further monomers are present, preferably less than 5%, more preferably less than 1%, most preferably no anionically charged monomers are present. The monomers may be present as blocks or randomly distributed, or a mix of blocks units and randomly distributed. The hydrophilic cationic polyvinyl alcohol can comprise residual other sub-units, such as from the initiator or other end-caps.

The hydrophobically modified cationic polyvinyl alcohol can have a weight average molecular weight of the starting polyvinyl alcohol of from 10 to 300 kDa, preferably from 50 to 250 kDa, more preferably from 100 to 220 kDa, as measured by aqueous gel permeation chromatography (GPC) with light scattering detection (SEC-MALLS).

The hydrophobically modified cationic polyvinyl alcohol may be characterized by a cationic charge density. Cationic charge density is typically expressed as milliequivalents of charge per gram of compound (mEq/g). The hydrophobically modified cationic polyvinyl alcohols of the present disclosure may be characterized by a cationic charge density (or “CCD”) ranging from 0.05 to 5.0 meq/g, preferably from 0.1 to 2.5 meq/g, more preferably from 0.2 to 1.0 meq/g.

Methods of determining degree of polymerization (number average (DPn) and weight average (DPw)), degree of substitution, and cationic charge density are well known.

Hydrophobically modified cationic polyvinyl alcohol polymer according to formula (I) can be made by polymerizing vinyl acetate monomers and then (partially) substituting the acetate groups with hydroxyl groups by hydrolysis to obtain polyvinyl alcohol (PVA). This polyvinyl alcohol polymer can be subsequently post-modified through a condensation reaction with a hydrophobic aldehyde, such as octanal or decanal, and cationic acetal to obtain the hydrophobically modified cationic polyvinyl alcohol polymer.

Within such a condensation reaction part of the hydroxyl groups of the polymer are converted into acetal groups. As such the hydrophobically modified cationic polyvinyl alcohol polymer comprises polyvinyl alcohol and hydrophobic and cationic polyvinyl acetal subunits, and consists of such subunits in the case of a 100% hydrolysed polyvinyl alcohol starting polymer prior to acetalization. When starting with a partially hydolyzed polyvinyl alcohol polymer (degree of hydrolysis of less than 100%), the hydrophobically modified cationic polyvinyl alcohol polymer will further comprise polyvinyl acetate subunits. These polyvinyl alcohol, hydrophobic polyvinyl acetal, cationic polyvinyl acetal, and optional polyvinyl acetate subunits can be organized in blocks or randomly, or a mix of block units and randomly distributed.

Hydrophobically modified polyvinyl alcohols according to formula (II) can be formed by hydrophobically modifying commercially available cationic polyvinyl alcohol polymers such as the cationically modified Poval® “CM” polyvinyl alcohols, supplied by Kuraray (for example: Poval®23-88CM). Hydrophobic modification can be carried out via post-modification through a condensation reaction with a hydrophobic aldehyde, such as octanal or decanal.

Alternatively, suitable hydrophobically modified cationic polyvinyl alcohol can also be prepared as described in Wang and Ye (J. Polym. Int. 2012; 61 pp 571-580) and Ma et al. (J. Appl. Polym. Sci. 2016, 133, 43888).

### Further Ingredients

The composition can comprise further ingredients such as those selected from: amphiphilic alkoxylated polyalkyleneimines, cyclic polyamines, triblock copolymers, hydrotropes, organic solvents, other adjunct ingredients such as those described herein, and mixtures thereof.

### Amphiphilic Alkoxylated Polyalkyleneimine

The composition of the present disclosure may further comprise from 0.05% to 2%, preferably from 0.07% to 1% by weight of the total composition of an amphiphilic polymer. Suitable amphiphilic polymers can be selected from the group consisting of: amphiphilic alkoxylated polyalkyleneimine and mixtures thereof. The amphiphilic alkoxylated polyalkyleneimine polymer has been found to reduce gel formation on the hard surfaces to be cleaned when the liquid composition is added directly to a cleaning implement (such as a sponge) before cleaning and consequently brought in contact with heavily greased surfaces, especially when the cleaning implement comprises a low amount to nil water such as when light pre-wetted sponges are used.

A preferred amphiphilic alkoxylated polyethyleneimine polymer has the general structure of formula (I):

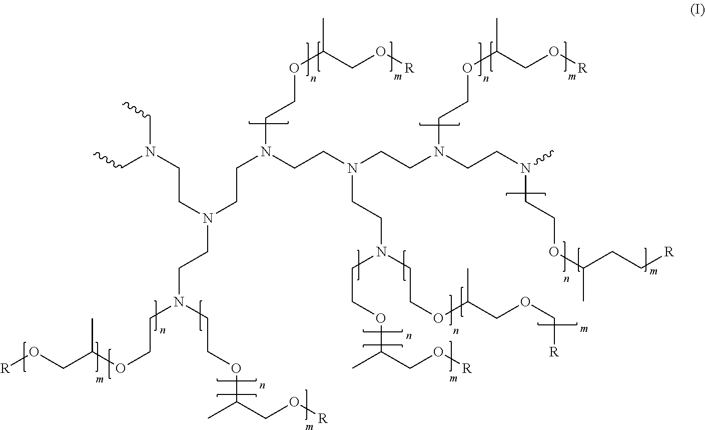

where the polyethyleneimine backbone has a weight average molecular weight of 600, n of formula (I) has an average of 10, m of formula (I) has an average of 7 and R of formula (I) is selected from hydrogen, a C₁-C₄ alkyl and mixtures thereof, preferably hydrogen. The degree of permanent quaternization of formula (I) may be from 0% to 22% of the polyethyleneimine backbone nitrogen atoms. The molecular weight of this amphiphilic alkoxylated polyethyleneimine polymer preferably is between 10,000 and 15,000 Da.

More preferably, the amphiphilic alkoxylated polyethyleneimine polymer has the general structure of formula (I) but wherein the polyethyleneimine backbone has a weight average molecular weight of 600 Da, n of Formula (I) has an average of 24, m of Formula (I) has an average of 16 and R of Formula (I) is selected from hydrogen, a C₁-C₄ alkyl and mixtures thereof, preferably hydrogen. The degree of permanent quaternization of Formula (I) may be from 0% to 22% of the polyethyleneimine backbone nitrogen atoms and is preferably 0%. The molecular weight of this amphiphilic alkoxylated polyethyleneimine polymer preferably is between 25,000 and 30,000, most preferably 28,000 Da.

The amphiphilic alkoxylated polyethyleneimine polymers can be made by the methods described in more detail in PCT Publication No. WO 2007/135645.

Alternatively, the compositions can be free of amphiphilic polymers.

### Cyclic Polyamine

The composition can comprise a cyclic polyamine having amine functionalities that helps cleaning. The composition of the present disclosure preferably comprises from 0.1% to 3%, more preferably from 0.2% to 2%, and especially from 0.5% to 1%, by weight of the total composition, of the cyclic polyamine.

The cyclic polyamine has at least two primary amine functionalities. The primary amines can be in any position in the cyclic amine but it has been found that in terms of grease cleaning, better performance is obtained when the primary amines are in positions 1,3. It has also been found that cyclic amines in which one of the substituents is —CH3 and the rest are H provided for improved grease cleaning performance.

Accordingly, the most preferred cyclic polyamine for use with the composition of the present disclosure are cyclic polyamine selected from the group consisting of 2-methylcyclohexane-1,3-diamine, 4-methylcyclohexane-1,3-diamine and mixtures thereof. These specific cyclic polyamines work to improve suds and grease cleaning profile through-out the dishwashing process when formulated together with the surfactant system of the composition of the present disclosure.

Suitable cyclic polyamines can be supplied by BASF, under the Baxxodur tradename, with Baxxodur ECX-210 being particularly preferred.

A combination of the cyclic polyamine and magnesium sulphate is particularly preferred. As such, the composition can further comprise magnesium sulphate at a level of from 0.001% to 2.0%, preferably from 0.005% to 1.0%, more preferably from 0.01% to 0.5% by weight of the composition.

### Triblock Copolymer

The composition of the present disclosure can comprise a triblock copolymer. The triblock co-polymers can be present at a level of from 1% to 20%, preferably from 3% to 15%, more preferably from 5% to 12%, by weight of the total composition. Suitable triblock copolymers include alkylene oxide triblock co-polymers, defined as a triblock co-polymer having alkylene oxide moieties according to Formula (I): (EO)ₓ(PO)_{y}(EO)ₓ, wherein EO represents ethylene oxide, and each x represents the number of EO units within the EO block. Each x can independently be on average of from 5 to 50, preferably from 10 to 40, more preferably from 10 to 30. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y can on average be from between 28 to 60, preferably from 30 to 55, more preferably from 30 to 48.

Preferably the triblock co-polymer has a ratio of y to each x of from 3:1 to 2:1. The triblock co-polymer preferably has a ratio of y to the average x of 2 EO blocks of from 3:1 to 2:1. Preferably the triblock co-polymer has an average weight percentage of total E-O of between 30% and 50% by weight of the tri-block co-polymer. Preferably the triblock co-polymer has an average weight percentage of total PO of between 50% and 70% by weight of the triblock co-polymer. It is understood that the average total weight % of EO and PO for the triblock co-polymer adds up to 100%. The triblock co-polymer can have an average molecular weight of between 2060 and 7880, preferably between 2620 and 6710, more preferably between 2620 and 5430, most preferably between 2800 and 4700. Average molecular weight is determined using a 1H NMR spectroscopy (see Thermo scientific application note No. AN52907).

Triblock co-polymers have the basic structure ABA, wherein A and B are different homopolymeric and/or monomeric units. In this case A is ethylene oxide (EO) and B is propylene oxide (PO). Those skilled in the art will recognize the phrase “block copolymers” is synonymous with this definition of “block polymers”.

Triblock co-polymers according to Formula (I) with the specific EO/PO/EO arrangement and respective homopolymeric lengths have been found to enhances suds mileage performance of the liquid hand dishwashing detergent composition in the presence of greasy soils and/or suds consistency throughout dilution in the wash process.

Suitable EO-PO-EO triblock co-polymers are commercially available from BASF such as Pluronic® PE series, and from the Dow Chemical Company such as Tergitol™ L series. Particularly preferred triblock co-polymer from BASF are sold under the tradenames Pluronic® PE6400 (MW ca 2900, ca 40 wt % EO) and Pluronic® PE 9400 (MW ca 4600, 40 wt % EO). Particularly preferred triblock co-polymer from the Dow Chemical Company is sold under the tradename Tergitol™ L64 (MW ca 2700, ca 40 wt % EO).

Preferred triblock co-polymers are readily biodegradable under aerobic conditions.

### Salt, Hydrotrope, Organic Solvent

The composition of the present disclosure may further comprise at least one active selected from the group consisting of: i) a salt, ii) a hydrotrope, iii) an organic solvent, and mixtures thereof.

The composition of the present disclosure may comprise from about 0.05% to about 2%, preferably from about 0.1% to about 1.5%, or more preferably from about 0.5% to about 1%, by weight of the total composition of a salt, preferably a monovalent or divalent inorganic salt, or a mixture thereof, more preferably selected from: sodium chloride, sodium sulphate, and mixtures thereof. Sodium chloride is most preferred.

The composition of the present disclosure may comprise from about 0.1% to about 10%, or preferably from about 0.5% to about 10%, or more preferably from about 1% to about 10% by weight of the total composition of a hydrotrope or a mixture thereof, preferably sodium cumene sulphonate.

The composition can comprise from about 0.1% to about 10%, or preferably from about 0.5% to about 10%, or more preferably from about 1% to about 10% by weight of the total composition of an organic solvent. Suitable organic solvents include organic solvents selected from the group consisting of: alcohols, glycols, glycol ethers, and mixtures thereof, preferably alcohols, glycols, and mixtures thereof. Ethanol is the preferred alcohol. Polyalkyleneglycols, especially polypropyleneglycol, is the preferred glycol, with polypropyleneglycols having a weight average molecular weight of from 750 Da to 1,400 Da being particularly preferred.

### Adjunct Ingredients

The composition may optionally comprise a number of other adjunct ingredients such as builders (preferably citrate), chelants, conditioning polymers, other cleaning polymers, surface modifying polymers, structurants, emollients, humectants, skin rejuvenating actives, enzymes, carboxylic acids, scrubbing particles, perfumes, malodor control agents, pigments, dyes, opacifiers, pearlescent particles, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g. carboxylic acids such as citric acid, HCl, NaOH, KOH, alkanolamines, carbonates such as sodium carbonates, bicarbonates, sesquicarbonates, and alike).

### Packaged Product

The hand dishwashing detergent composition can be packaged in a container, typically plastic containers. Suitable containers comprise an orifice. Suitable containers include traditional upright dosing containers, where the orifice is at the top of the container, and inverted/bottom dosing containers, where the orifice is at the bottom of the container. For inverted/bottom dosing containers, the orifice may be capped and/or the orifice may comprise a slit valve, such as described in U.S. Pat. No. 10,611,531. Typically, the container comprises a cap, with the orifice typically comprised on the cap. The cap can comprise a spout, with the orifice at the exit of the spout. The spout can have a length of from 0.5 mm to 10 mm.

The orifice can have an open cross-sectional surface area at the exit of from 3 mm2 to 20 mm2, preferably from 3.8 mm2 to 12 mm2, more preferably from 5 mm2 to 10 mm2, wherein the container further comprises the composition according to the present disclosure. The cross-sectional surface area is measured perpendicular to the liquid exit from the container (that is, perpendicular to the liquid flow during dispensing).

The container can typically comprise from 200 ml to 5,000 ml, preferably from 350 ml to 2000 ml, more preferably from 400 ml to 1,000 ml of the liquid hand dishwashing detergent composition.

### Method of Washing

The present disclosure is further directed to a method of manually washing dishware with the composition of the present disclosure. The method comprises the steps of delivering a composition of the present disclosure to a volume of water to form a wash solution and immersing the dishware in the wash solution. The dishware is be cleaned with the composition in the presence of water.

The dishware can be rinsed. By “rinsing”, it is meant herein contacting the dishware cleaned with the process according to the present disclosure with substantial quantities of appropriate solvent, typically water. By “substantial quantities”, it is meant usually about 1 to about 20 L, or under running water.

The composition herein can be applied in its diluted form. Soiled dishware is contacted with an effective amount, typically from about 0.5 mL to about 20 mL (per about 25 dishes being treated), preferably from about 3 mL to about 10 mL, of the composition, preferably in liquid form, of the present disclosure diluted in water. The actual amount of composition used will be based on the judgment of the user and will typically depend upon factors such as the particular product formulation of the composition, including the concentration of active ingredients in the composition, the number of soiled dishes to be cleaned, the degree of soiling on the dishes, and the like. Generally, from about 0.01 mL to about 150 mL, preferably from about 3 mL to about 40 mL of a composition of the present disclosure is combined with from about 2,000 mL to about 20,000 mL, more typically from about 5,000 mL to about 15,000 mL of water in a sink. The soiled dishware is immersed in the sink containing the diluted compositions then obtained, before contacting the soiled surface of the dishware with a cloth, sponge, or similar cleaning implement. The cloth, sponge, or similar cleaning implement may be immersed in the composition and water mixture prior to being contacted with the dishware, and is typically contacted with the dishware for a period of time ranged from about 1 to about 10 seconds, although the actual time will vary with each application and user. The contacting of cloth, sponge, or similar cleaning implement to the dishware is accompanied by a concurrent scrubbing of the dishware.

Alternatively, the composition herein can be applied in its neat form to the dish to be treated. By “in its neat form”, it is meant herein that said composition is applied directly onto the surface to be treated, or onto a cleaning device or implement such as a brush, a sponge, a nonwoven material, or a woven material, without undergoing any significant dilution by the user (immediately) prior to application. “In its neat form”, also includes slight dilutions, for instance, arising from the presence of water on the cleaning device, or the addition of water by the consumer to remove the remaining quantities of the composition from a bottle. Therefore, the composition in its neat form includes mixtures having the composition and water at ratios ranging from 50:50 to 100:0, preferably 70:30 to 100:0, more preferably 80:20 to 100:0, even more preferably 90:10 to 100:0 depending on the user habits and the cleaning task.

### Test Methods

### Viscosity Measurement

The viscosity is measured using a controlled stress rheometer (such as an HAAKE MARS from Thermo Scientific, or equivalent), using a 60 mm 1º cone and a gap size of 52 microns at 20° C. After temperature equilibration for 2 minutes, the sample is sheared at a shear rate of 10 s⁻¹ for 30 seconds. The reported viscosity of the liquid hand dishwashing detergent compositions is defined as the average shear stress between 15 seconds and 30 seconds shearing divided by the applied shear rate of 10 s⁻¹ at 20° ° C.

### Molecular Weight Determination by Gel Permeation Chromatography:

Gel Permeation Chromatography (GPC) with Multi-Angle Light Scattering (MALS) and Refractive Index (RI) Detection (GPC-MALS/RI) is a well-known system to directly measure the weight average molecular weight, M_{w}, and number average molecular weight, Mₙ, of a polymer without the need for comparisons with known reference standards.

The true number-average molecular weight, Mₙ, of polymers can be obtained by GPC coupled with light-scattering detection and refractive index detection even if the composition and therefore the refractive index increment varies with elution volume, provided slices taken are sufficiently monodisperse with respect to molecular weight and composition.

For example, the molecular weight distribution of polymer can be measured using a Liquid Chromatography system such as an Agilent 1260 Infinity pump system with OpenLab Chemstation software (from Agilent Technology, Santa Clara, CA, USA) provided with two ultrahydrogel linear columns, 7.8 mm ID×300 mm length used in series (S/N 002C180181 VE077 and 005C180181 VE084, supplied by Waters Corporation of Milford, Mass., USA) and an ultrahydrogel guard column (6 mm ID×40 mm length, S/N2016260401BE105, also supplied Waters Corporation of Milford, Mass., USA) installed between the injector and the analytical column to prevent any impurities and suspended solids from reaching the analytical column, operated at 40° C. A multiangle light scattering (MALS) detector DAWN® and a differential refractive index (RI) detector (Wyatt Technology of Santa Barbara, Calif., USA) controlled by Wyatt Astra® software can be used for the detection.

Since the analytes are spread over a relatively narrow time window, an isocratic rather than gradient elution method can be used. Isocratic means that the mixture of your mobile phase is consistent over the complete testing time. Using a gradient implies that the compounding of the eluent mixture is changed during measurement and so influences the retention of analytes. The separation can be either accelerated or decelerated when using a gradient method.

0.1M sodium nitrate in water containing 0.02% sodium azide is used as the mobile phase. Samples are prepared by dissolving the polymer in the mobile phase at ˜1.0 mg per ml and by mixing the solution overnight at room temperature to ensure full hydration of the polymer. The sample is then filtered through a 0.8 μm Versapor membrane filter (AP4189, supplied by PALL, Life Sciences, NY, USA) into the LC autosampler vial using a 3-ml syringe. The sample is then pumped into the columns at a flow rate of 1.0 mL/min.

The number average and weight average molecular weights of the polymer are calculated from the dn/dc (differential change of refractive index with concentration) measurements, as provided by the Astra detector software.

### Water-Sheeting:

The speed of drying is related to the degree of water-sheeting. The higher the water-sheeting, the less water retained on the wet article.

The water sheeting behaviour is evaluated by washing grey ceramic plates (“Dinera” plates, 26 cm diameter, sourced form IKEA) with the hand dishwashing detergent test compositions, followed by scoring the amount of water sheeting observed on the plate when leaving them vertically on a drying rack. More particularly:

A sponge (Scotch-Brite® Classic-schuurspons van cellulose—supplied by 3M Belgium-dimension: 7 cm*10 cm) is homogeneously wetted with water of hardness 0.36 mmol/l CaCO₃ equivalence, at 25° C., by saturating the sponge with water, and subsequently manually squeezing until no further water is squeezed out).

1 ml of the hand dishwashing composition is homogeneously distributed over the sponge. The sponge is manually squeezed with full force 4 times above the ceramic plate using one hand to create foam, followed by washing the plate in 10 circular clockwise motions covering the edges as well as the center part of the plate, so that the full plate is treated with the foam.

The plate is then rinsed for 30 seconds under a running tap (25° ° C. water of having the same water hardness as before) at a sufficient flow rate to enable full foam removal and full coverage with water after which the plate is placed vertically on a drying rack under standard room conditions (20+/−1° C.).

The water running down the plate is then visually evaluated and a score of between 0-100% is given depending on the amount of water that has run down the plate in the first 30 sec, and therefore leaving an area of the plate already dry. 0% corresponds to water remaining on the full plate, 50% indicates that the half of the plate is covered with a film of water, and 100% indicating that no water film is visibly present.

### Foam Rinsing Test Method:

Conical centrifuge tubes (50 ml, supplied by Corning under the Falcon™ tradename) are mounted together in a placeholder rack to allow parallel measurements with matching exposure conditions.
1. 10 g of test solution for each leg, consisting of a 1.0 wt % solution of the respective detergent composition in water of targeted water hardness at room temperature (20° C.), is added into each tube.
2. All the tubes are simultaneously shaken 10 times in a vertical up and down direction at a speed of 2 strokes per second (1 stroke reflects a 25 cm vertical up and down motion), such that the liquid makes contact once with the screw cap during each stroke movement step, in order to generate the suds.
3. Within 30s after shaking, the initial suds volume (in ml) is determined.
4. The liquid is then decanted such that only the suds remain.
5. The centrifuge tubes containing the suds are then gently filled via a calibrated bottle dispenser (such as a Dispensette® bottle dispenser from Sigma Aldrich) via the tube wall with 10 mL water rinse solution of targeted water hardness at 20° C.
6. All the tubes are again simultaneously shaken.
7. Within 30s after shaking, the suds volume is re-measured and the liquid is decanted again. In this way, steps 5 through 7 represent a rinse cycle.
8. The rinse cycle is repeated until the suds volume reaches 0 ml.
9. The following data are obtained by Boltzmann fitting and the average of 3 replicates is reported: Starting suds volume—v50 (amount of cycles to reach half of the starting suds volume). A Boltzmann fitting of the curve is done by nonlinear regression: Start/(1+exp (−(v50-cycle)/slope)).

### EXAMPLES

### Synthesis Examples

Cationic polyvinyl alcohol 1, cationic polyvinyl alcohol 2, and cationic polyvinyl alcohol A were prepared as followed. Cationic polyvinyl alcohols 1 and 2 comprised hydrophobic modifications and were of use in the compositions of the present disclosure. Since cationic polyvinyl alcohol A did not comprise any hydrophobic monomer (a=0), the compositions comprising it was comparative. Since the hydrolysed polyvinyl alcohol comprised neither any hydrophobic monomer nor cationic monomer, the composition comprising them was also comparative.

The resultant structures are given in table 1.

TABLE 1
Polyvinyl alcohols of use in inventive and comparative compositions:

| | | | | | | | | | | CCD | |
|---|---|---|---|---|---|---|---|---|---|---|---|
| | a | b | c | d | e | f | Rx | Ry | Rz | (mEq/g) | Mw² |
| Cationic polyvinyl | 2.7 | 4.7 | 81.7 | 10.8 | 9 | 3 | CH₃ | CH₃ | CH₃ | 0.8 | 130 |
| alcohol 1 | | | | | | | | | | | |
| Cationic polyvinyl | 2.6 | 4.7 | 81.5 | 11.2 | 6 | 3 | CH₃ | CH₃ | CH₃ | 0.8 | 130 |
| alcohol 2 | | | | | | | | | | | |
| Cationic polyvinyl | 0 | 5.1 | 83.5 | 11.4 | — | 3 | CH₃ | CH₃ | CH₃ | 0.9 | 130 |
| alcohol A* | | | | | | | | | | | |
| Hydrolysed | 0 | 0 | 88 | 12 | — | — | — | — | — | — | 130 |
| polyvinyl alcohol¹* | | | | | | | | | | | |

¹Poval 18-88, 88% hydrolysed polyvinyl alcohol, sourced from Sigma Aldrich
²of the starting polyvinyl alcohol
*Of use in comparative compositions

Quaternization of 4-(dimethylamino)butyraldehyde Diethyl Acetal (Cationic Acetal)

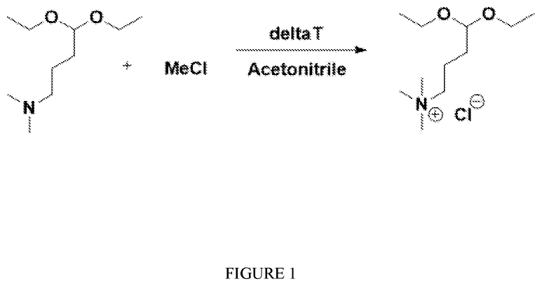

4-(dimethylamino)butyraldehyde diethyl acetal was quaternized using the following procedure (see FIG. 1):

29 mL of 4-(dimethylamino)butyraldehyde diethyl acetal and 60 mL of acetonitrile were added to a 160 mL Parr reactor. The reactor was purged three times with 50 psi nitrogen. 8.6 g of chloromethane gas were added and the reactor heated to 60° C. and stirred for 23 h. Afterwards, the heat was turned off and once the mixture was cooled to room temperature, it was purged with nitrogen. The material was precipitated into diethyl ether at a temperature of −18° C. and most of the diethyl ether was decanted off. The precipitate was washed with ice cold diethyl ether and residual diethyl ether was removed using a rotary evaporator, which yielded a viscous, yellow oil at room temperature. Traces of unreacted amine or aldehyde due to hydrolysis of the acetal might be present and can be removed by means known to the skilled person.

The chemical structure of the cationic acetal was confirmed by 1H NMR spectroscopy. The spectra were recorded at 25+0.2° C. using a Bruker AVANCE III 300 MHz Spectrometer, equipped with a broad band observe probe with Z-gradient. 10 mg of cationic acetal was dissolved in 0.7-0.8 mL of D₂O.

### Synthesis of Hydrophobically Modified Cationic Polyvinyl Alcohol 1:

A 10 wt % aqueous solution of polyvinyl alcohol (Mowiol 18-88, sourced from Sigma Aldrich, viscosity of 17.5 mPa·s as a 4% aqueous solution in DI water at 20° C.) was prepared by placing 90 g of demineralized water into a beaker, covering it with foil, heating the water to 90° C. and adding 10 g of the polyvinyl alcohol incrementally while stirring. Once the polymer was fully dissolved and a homogeneous solution was obtained, the heat was turned off and the solution was allowed to cool down to room temperature. To this solution, 0.9 mL of 12 M hydrochloric acid solution was added. 2.44 g of the cationic acetal prepared earlier was weighed into a vial and dissolved in 10 mL of DI water. This solution was added to the beaker and residual material was washed into the beaker using 2 mL of DI water. Afterwards, 0.8 mL decanal was added to the beaker and the beaker was closed with a lid. The mixture was stirred at room temperature for 24 hours. During this time, additional DI water was added to ensure proper stirring and avoiding the material gelling. The reaction mixture was brought back to a pH in the range 6-7 using 13.5 mL of an aqueous sodium hydroxide solution (1 M). The resulting reaction mixture was poured into a freeze dryer tray, diluted with 1 L of additional demineralized water and placed into the freezer. Once the mixture was frozen, it was placed into the freeze dryer. Freeze drying yielded a white polymer containing residual salts and traces of unreacted cationic acetal, aldehyde, or intermolecular reaction by-products. The material was dissolved in DI water and dialyzed against DI water (dialysis tube pore size 3.5 kDa MWCO) to remove small molecule impurities. The solution was freeze-dried to yield the purified polymer.

### Synthesis of Hydrophobically Modified Cationic Polyvinyl Alcohol 2:

A 10 wt % aqueous solution of polyvinyl alcohol (Mowiol 18-88, sourced from Sigma Aldrich, viscosity of 17.5 mPa·s as a 4% aqueous solution in DI water at 20° C.) was prepared by placing 90 g of demineralized water into a beaker, covering it with foil, heating the water to 90° C. and adding 10 g of the polyvinyl alcohol incrementally while stirring. Once the polymer was fully dissolved and a homogeneous solution was obtained, the heat was turned off and the solution was allowed to cool down to room temperature. To this solution, 0.9 mL of 12 M hydrochloric acid solution was added. 2.44 g of cationic acetal was weighed into a vial and dissolved in 10 mL of DI water. This solution was added to the beaker and residual material was washed into the beaker using 2 mL of DI water. Afterwards, 0.6 mL heptanal was added to the beaker and the beaker was closed with a lid. The mixture was stirred at room temperature for 24 hours. The reaction mixture was brought back to a pH 6-7 using 13 mL of an aqueous sodium hydroxide solution (1 M). The resulting reaction mixture was poured into a freeze dryer tray, diluted with 1 L of additional demineralized water and placed into the freezer. Freeze drying yielded a white polymer containing residual salts which might further contain traces of unreacted acetal, aldehyde, and its respective oxidation product or intermolecular reaction by-products.

### Synthesis of Cationic Polyvinyl Alcohol A:

A 10 wt % aqueous solution of polyvinyl alcohol (Mowiol 18-88, sourced from Sigma Aldrich, viscosity of 17.5 mPa·s as a 4% aqueous solution in DI water at 20° C.) was prepared by placing 225 g of demineralized water into a beaker, covering it with foil, heating the water to 90° C. and adding 25 g of the polyvinyl alcohol incrementally while stirring. Once the polymer was fully dissolved and a homogeneous solution was obtained, the heat was turned off and the solution was allowed to cool down to room temperature. To this cooled down solution, 2.1 mL of 12 M hydrochloric acid solution was added. 6.11 g of the cationic acetal (amount depending on targeted degree of acetalization) was weighed into a vial, dissolved in 10 mL of DI water and added to the beaker. Additional 2 mL of DI water was used to wash any residual acetal material into the beaker and the beaker was closed with a lid. The mixture was stirred at room temperature for 12 to 24 hours. The reaction mixture was brought back to a pH of 6-7 using 32 mL of aqueous sodium hydroxide solution (1 M). The resulting reaction mixture was poured into a freeze dryer tray, diluted with 1 L of additional demineralized water and placed into the freeze dryer. Freeze drying yielded a white polymer containing residual salts which might further contain traces of unreacted cationic acetal, unreacted cationic acetal that hydrolyzed to the aldehyde and its respective oxidation product or intermolecular reaction by-products.

### Comparative Tests:

The following compositions comprising an amine oxide surfactant as co-surfactant were formulated by simple mixing of the starting ingredients. Example 1 comprised cationic polyvinyl alcohol 1, while Example 2 comprised cationic polyvinyl alcohol 2. Since both cationic polyvinyl alcohol 1 and 2 were hydrophobically modified, the compositions of examples 1 and 2 were of the present disclosure. Example A comprised cationic polyvinyl alcohol A, while example B comprised cationic polyvinyl alcohol B. Since neither cationic polyvinyl alcohol A nor B comprised hydrophobic modifications, both examples A and B were comparative. Example C comprised a hydrolysed (saponified) polyvinyl alcohol which was neither cationic, nor hydrophobically modified. As such, example C was also comparative. Since example D comprised a cationic hydroxyethyl cellulose rather than a hydrophobically modified polyvinyl alcohol, example D was also comparative, as well as being relevant for the state of the art since such polymers are known for providing rinsing benefits.

TABLE 2
Comparative and inventive liquid hand dishwashing detergent compositions:

| wt % (100% active basis) | Ex 1 | Ex 2 | Ex A* | Ex B* | Ex C* | Ex D* |
|---|---|---|---|---|---|---|
| C12-13 alkyl EO0.6 sulfate (42.03% | 9.5 | 9.5 | 9.5 | 9.5 | 9.5 | 9.5 |
| branching) | | | | | | |
| C12-14 dimethyl amine oxide | 4.7 | 4.7 | 4.7 | 4.7 | 4.7 | 4.7 |
| C9-11 EO8 nonionic surfactant³ | 7.1 | 7.1 | 7.1 | 7.1 | 7.1 | 7.1 |
| C12-14 alkyl polyglucoside⁴ | 7.1 | 7.1 | 7.1 | 7.1 | 7.1 | 7.1 |
| EO-PO-EO copolymer⁵ | 0.5 | 0.5 | 0.5 | 0.5 | 0.5 | 0.5 |
| 2-methyldiaminocyclohexane⁶ | 0.22 | 0.22 | 0.22 | 0.22 | 0.22 | 0.22 |
| Sodium citrate | 1.0 | 1.0 | 1.0 | 1.0 | 1.0 | 1.0 |
| MgCl2 | 0.2 | 0.2 | 0.2 | 0.2 | 0.2 | 0.2 |
| PPG (MW2000) | 0.4 | 0.4 | 0.4 | 0.4 | 0.4 | 0.4 |
| Sodium cumene sulfonate | 2.25 | 2.25 | 2.25 | 2.25 | 2.25 | 2.25 |
| Ethanol | 3.1 | 3.1 | 3.1 | 3.1 | 3.1 | 3.1 |
| Cationic polyvinyl alcohol 1 | 0.5 | 0 | 0 | 0 | 0 | 0 |
| Cationic polyvinyl alcohol 2 | 0 | 0.5 | 0 | 0 | 0 | 0 |
| Cationic polyvinyl alcohol A | 0 | 0 | 0.5 | 0 | 0 | 0 |
| Cationic polyvinyl alcohol B⁷ | 0 | 0 | 0 | 0.5 | 0 | 0 |
| Hydrolysed polyvinyl alcohol⁸ | 0 | 0 | 0 | 0 | 0.5 | 0 |
| Cationic cellulose9 | 0 | 0 | 0 | 0 | 0 | 0.5 |
| Water and minors (perfume, dye, | bal. | bal. | bal. | bal. | bal. | bal. |
| preservatives . . .) | | | | | | |
| pH (10% solution in demi water) | 7.5 | 7.5 | 7.5 | 7.5 | 7.5 | 7.5 |

*Comparative
³sold under the tradename of Neodol ®, supplied by Shell
⁴sold under the tradename of Glucopon 600 CSUP by BASF
⁵Ethylene oxide / propylene oxide block copolymer sold under the tradename Tergitol ® L64E by Dow
⁶sold under the tradename Baxxodur ® ECX210 by BASF
⁷Poval ® 23-88CM, a hydrolysed cationic polyvinyl alcohol (viscosity 20-26 mPa · s, molecular weight 177 kDa, average degree of hydrolysation of 88, supplied by Kuraray) having the structure according to formula (II) with m = 0, n = 10.1, o = 88, and p = 1.9, r is 3 and Rₛ, Rₜ, and Rᵤ are all methyl
⁸Hydrolysed polyvinyl alcohol of table 1
⁹Polymeric quaternary ammonium salt of hydroxyethyl cellulose, sold under the tradename Supracare ® 212 by DOW, cationic charge density (CCD) of from 1.1 to 1.6 mEq/g

### Comparison of Drying Benefit:

The drying benefit from inventive example 1, and comparative examples B, C and D were evaluated by measuring the water-sheeting results after rinsing, using the procedures described herein. The results are given below:

TABLE 3
Results of drying benefit test:

| wt % (100% active basis) | Ex 1 | Ex B* | Ex C* | Ex D* |
|---|---|---|---|---|
| Cationic polyvinyl | 0.5 | 0 | 0 | 0 |
| alcohol 1 | | | | |
| Cationic polyvinyl | 0 | 0.5 | 0 | 0 |
| alcohol B⁷ | | | | |
| Hydrolysed polyvinyl | 0 | 0 | 0.5 | 0 |
| alcohol⁸ | | | | |
| Cationic cellulose⁹ | 0 | 0 | 0 | 0.5 |
| Water sheeting % | 95 | 75 | 5 | 50 |

As can be seen from the results of comparative example C of Table 2, unmodified hydrolysed polyvinyl alcohols provide negligible drying benefit, as seen from the water-sheeting results. As expected from the prior art, cationic cellulose provides a noticeable improvement in drying benefit. The drying benefit is further improved when the cationic cellulose is replaced by a non-hydrophobically modified polyvinyl alcohol (Cationic polyvinyl alcohol B, used in the composition of comparative example B). However, as can be seen from the water-sheeting results from example 1, an even greater improvement in drying is achieved when a hydrophobically modified polyvinyl alcohol is used.

### Comparison of Rinse Benefit:

The rinse benefit from inventive examples 1 and 2, and comparative examples A, B, and C were evaluated using the rinse benefit test described earlier. The results are given below:

TABLE 4
Results of rinse benefit test:

| wt % (100% active basis) | Ex 1 | Ex 2 | Ex A* | Ex B* | Ex C* |
|---|---|---|---|---|---|
| Cationic polyvinyl | 0.5 | 0 | 0 | 0 | 0 |
| alcohol 1 | | | | | |
| Cationic polyvinyl | 0 | 0.5 | 0 | 0 | 0 |
| alcohol 2 | | | | | |
| Cationic polyvinyl | 0 | 0 | 0.5 | 0 | 0 |
| alcohol A | | | | | |
| Cationic polyvinyl | 0 | 0 | 0 | 0.5 | 0 |
| alcohol B⁷ | | | | | |
| Hydrolysed polyvinyl | 0 | 0 | 0 | 0 | 0.5 |
| alcohol⁸ | | | | | |
| Water and minors | bal. | bal. | bal. | bal. | bal. |
| (perfume, dye) | | | | | |
| Initial suds height (ml) | 29.75 | 32.30 | 32.33 | 32.13 | 31.44 |
| Av. number of rinse | 2.91 | 3.18 | 3.49 | 3.62 | 4.00 |
| cycles to reach V50 | | | | | |

The results from comparative example C show that polyvinyl alcohol which is neither cationic nor hydrophobically modified does not improve rinsability (for reference, compositions which did not comprise any polymer has a starting suds level of 31.9 and an average number of rinse cycles to V50 of 3.88).

The results from comparative examples A and B show that cationic polyvinyl alcohol which has not been hydrophobically modified results in a small improvement in rinsing.

The results from inventive examples 1 and 2 show that cationic polyvinyl alcohol which has been hydrophobically modified results in a much greater improvement in rinsing. The slightly lower starting suds from example 1 does not explain the improvement in rinsing since the V50 is the average number of rinse cycles to halve the original suds height.

The following compositions comprising a betaine as co-surfactant were made by simple mixing of the individual starting ingredients and the rinsing benefit is also assessed.

From the results of table 5, it can be seen that the hydrophobically modified cationic polyvinyl alcohol also improves rinsing when incorporated into compositions comprising alkyl ether sulfate anionic surfactant and betaine co-surfactant.

From the results of table 6, it can be seen that the hydrophobically modified cationic polyvinyl alcohol also improves rinsing when incorporated into compositions comprising alkyl sulfate (i.e. unethoxylated) anionic surfactant and betaine co-surfactant.

TABLE 5
Rinsing benefit from comparative and inventive liquid hand
dishwashing detergent compositions comprising alkyl ethoxylated
sulfate anionic surfactant and betaine co-surfactant:

| wt % (100% active basis) | Ex 3 | Ex 4 | Ex E* | Ex F* | Ex G* |
|---|---|---|---|---|---|
| C12-13 alkyl EO0.6 sulfate | 19.6 | 19.6 | 19.6 | 19.6 | 19.6 |
| (34.7% branching) | | | | | |
| C12-14 amidopropyl | 6.5 | 6.5 | 6.5 | 6.5 | 6.5 |
| betaine⁸ | | | | | |
| C9-11 EO8 nonionic | 1.0 | 1.0 | 1.0 | 1.0 | 1.0 |
| surfactant¹ | | | | | |
| NaCl | 0.7 | 0.7 | 0.7 | 0.7 | 0.7 |
| PPG (MW2000) | 0.7 | 0.7 | 0.7 | 0.7 | 0.7 |
| Ethanol | 1.8 | 1.8 | 1.8 | 1.8 | 1.8 |
| Cationic polyvinyl | 0.5 | 0 | 0 | 0 | 0 |
| alcohol 1 | | | | | |
| Cationic polyvinyl | 0 | 0.5 | 0 | 0 | 0 |
| alcohol 2 | | | | | |
| Cationic polyvinyl | 0 | 0 | 0.5 | 0 | 0 |
| alcohol A | | | | | |
| Cationic polyvinyl | 0 | 0 | 0 | 0.5 | 0 |
| alcohol B⁷ | | | | | |
| Hydrolysed polyvinyl | 0 | 0 | 0 | 0 | 0.5 |
| alcohol⁸ | | | | | |
| Water and minors | bal. | bal. | bal. | bal. | bal. |
| (perfume, dye, | | | | | |
| preservatives . . . ) | | | | | |
| pH (10% solution in | 9.0 | 9.0 | 9.0 | 9.0 | 9.0 |
| demi water) | | | | | |
| Initial suds height (ml) | 29.16 | 29.65 | 30.87 | 30.61 | 31.36 |
| Av. number of rinse | 2.97 | 2.96 | 3.05 | 3.24 | 3.36 |
| cycles to reach V50 | | | | | |

⁸sold under the tradename Dehyton ® KE UP by BASF

TABLE 6
Rinsing benefit from comparative and inventive liquid hand
dishwashing detergent compositions comprising alkyl sulfate
anionic surfactant and betaine co-surfactant:

| wt % (100% active basis) | Ex 5 | Ex H* | Ex I* | Ex J* |
|---|---|---|---|---|
| C12-13 alkyl sulfate | 19.81 | 19.81 | 19.81 | 19.81 |
| (30.4% branching) | | | | |
| C12-14 amidopropyl | 6.6 | 6.6 | 6.6 | 6.6 |
| betaine⁸ | | | | |
| C9-11 E08 nonionic | 2.0 | 2.0 | 2.0 | 2.0 |
| surfactant¹ | | | | |
| NaCl | 0.7 | 0.7 | 0.7 | 0.7 |
| PPG (MW2000) | 0.9 | 0.9 | 0.9 | 0.9 |
| Ethanol | 3.1 | 3.1 | 3.1 | 3.1 |
| Cationic polyvinyl | 0.5 | 0 | 0 | 0 |
| alcohol 1 | | | | |
| Cationic polyvinyl | 0 | 0.5 | 0 | 0 |
| alcohol A | | | | |
| Cationic polyvinyl | 0 | 0 | 0.5 | 0 |
| alcohol B⁷ | | | | |
| Hydrolysed polyvinyl | 0 | 0 | 0 | 0.5 |
| alcohol⁸ | | | | |
| Water and minors | bal. | bal. | bal. | bal. |
| (perfume, dye, | | | | |
| preservatives . . . ) | | | | |
| pH (10% solution in | 9.0 | 9.0 | 9.0 | 9.0 |
| demi water) | | | | |
| Initial suds height (ml) | 26.67 | 31.27 | 30.71 | 30.03 |
| Av. number of rinse | 3.04 | 3.3 | 3.44 | 3.65 |
| cycles to reach V50 | | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any present disclosure disclosed or claimed herein or that it alone, or in any combination with any other reference or references, teaches, suggests or discloses any such present disclosure. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this present disclosure.

What is claimed is:

1. A liquid hand dishwashing detergent composition comprising:
a. from about 5.0% to about 50% by weight of the liquid hand dishwashing detergent composition of a surfactant system, wherein the surfactant system comprises anionic surfactant; and
b. from about 0.01% to about 5% of a hydrophobically modified cationic polyvinyl alcohol.

2. The liquid hand dishwashing detergent composition according to claim 1, wherein the detergent composition comprises from about 0.05% to about 3% by weight of the detergent composition of the hydrophobically modified cationic polyvinyl alcohol.

3. The liquid hand dishwashing detergent composition according to claim 2, wherein the detergent composition comprises from about 0.1% to about 2% by weight of the detergent composition of the hydrophobically modified cationic polyvinyl alcohol.

4. The liquid hand dishwashing detergent composition according to claim 1, wherein the hydrophobically modified cationic polyvinyl alcohol is selected from:
a. a hydrophobically modified cationic polyvinyl alcohol having the formula (I): 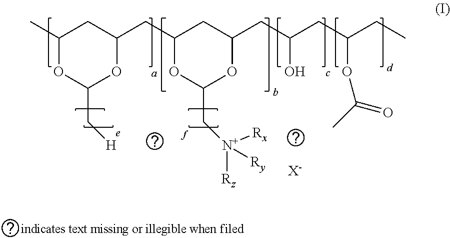
wherein:
a is from about 0.5 to about 5.0;
b is from 0.5 to 20;
c is from 40 to 98;
d is from 1.0 to 25;
wherein a, b, c, and d are average mol % of the monomers present, such that a+b+c+d add up to at least about 90;
e is a number average of from about 3.0 to about 18;
f is a number average of from about 2.0 to about 5.0;
Rx is a C1 to C3 alkyl;
Ry is a C1 to C3 alkyl; and
Rz is a H or C1 to C3 alkyl; or
b. a hydrophobically modified cationic polyvinyl alcohol having the formula (II): 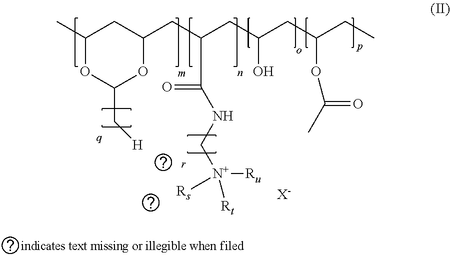
wherein:
m is from about 0.5 to about 5.0;
n is from about 0.1 to about 10;
is from about 40 to about 98;
p is from about 1.0 to about 25;
wherein m, n, o, and p are average mol % of the monomers present, such that m+n+o+p add up to at least about 90;
q is a number average of from about 3.0 to about 18;
r is a number average of from about 2.0 to about 5.0;
Rₛ is a C1 to C3 alkyl;
Rₜ is a C1 to C3 alkyl; and
Rᵤ is a H or C1 to C3 alkyl.

5. The liquid hand dishwashing detergent composition according to claim 4, wherein:
a. in the hydrophobically modified cationic polyvinyl alcohol having the formula (I):
a is from about 1.0 to about 4.0;
b is from about 2.0 to about 10;
c is from about 65 to about 95;
d is from about 3.0 to 20 about;
e is a number average of from about 3.0 to about 15;
f is a number average of from about 2.0 to about 4.0;
Rx is a C1 alkyl;
Ry is a C1 alkyl; and
Rz is a C1 alkyl; or
b. in the hydrophobically modified cationic polyvinyl alcohol having the formula (II):
m is from about 1.0 to about 4.0;
n is from about 0.5 to about 5.0;
is from about 65 to about 95;
p is from about 3.0 to about 20;
q is a number average of from about 3.0 to about 15;
r is a number average of from about 2.0 to about 4.0;
Rₛ is a C1 alkyl;
Rₜ is a C1 alkyl; and
Rᵤ is a C1 alkyl.

6. The liquid hand dishwashing detergent composition according to claim 1, wherein the hydrophobically modified cationic polyvinyl alcohol is characterized by a weight average molecular weight of the starting polyvinyl alcohol of from about 10 to about 300 kDa.

7. The liquid hand dishwashing detergent composition according to claim 6, wherein the hydrophobically modified cationic polyvinyl alcohol is characterized by a weight average molecular weight of the starting polyvinyl alcohol of from about 50 to about 250 kDa.

8. The liquid hand dishwashing detergent composition according to claim 1, wherein the composition comprises from about 6.0% to about 40% by weight of the detergent composition of the surfactant system.

9. The liquid hand dishwashing detergent composition according to claim 1, wherein the surfactant system comprises at least about 40% by weight of the surfactant system of an anionic surfactant.

10. The liquid hand dishwashing detergent composition according to claim 1, wherein the anionic surfactant comprises at least about 70% by weight of the anionic surfactant of alkyl sulphated anionic surfactant.

11. The liquid hand dishwashing detergent composition according to claim 10, wherein the alkyl sulphated anionic surfactant has a number average alkyl chain length of 8 to 18 carbon atoms.

12. The liquid hand dishwashing detergent composition according to claim 1, wherein the anionic surfactant comprises at least about 70% by weight of the anionic surfactant of alkyl alkoxy sulphate anionic surfactant.

13. The liquid hand dishwashing detergent composition according to claim 1, wherein the anionic surfactant comprises an unalkoxylated alkyl sulphate anionic surfactant or an alkyl alkoxy sulphate anionic surfactant having a weight average degree of branching of at least about 10%.

14. The liquid hand dishwashing detergent composition according to claim 1, wherein the surfactant system further comprises a co-surfactant selected from the group consisting of amphoteric co-surfactant, zwitterionic co-surfactant, and mixtures thereof.

15. The liquid hand dishwashing detergent composition according to claim 14, wherein the anionic surfactant and the co-surfactant are present in a weight ratio of from about 1:1 to about 8:1.

16. The liquid hand dishwashing composition according to claim 14, wherein the co-surfactant is an amphoteric surfactant, which is an amine oxide surfactant.

17. The liquid hand dishwashing composition according to claim 14, wherein the co-surfactant is a zwitterionic surfactant, which is a betaine surfactant.

18. The liquid hand dishwashing composition according to claim 1, wherein the surfactant system further comprises a nonionic surfactant.

19. The liquid hand dishwashing composition according to claim 18, wherein the nonionic surfactant is selected from the group consisting of alkoxylated alcohol nonionic surfactants, alkyl polyglucoside nonionic surfactants, and mixtures thereof.

20. A method of cleaning dishes comprising the steps of:
delivering a composition according to claim 1 to a volume of water to form a wash solution; and
immersing the dishware in the wash solution.
